(19) United States
(12) Patent Application Publication
(10) Pub. No.: US 2024/0212186 A1
(43) Pub. Date: Jun. 27, 2024

(54) METHOD AND SYSTEM FOR ESTIMATING DEPTH INFORMATION

(71) Applicants: Continental Autonomous Mobility Germany GmbH, Ingolstadt (DE); Volkswagen AG, Wolfsburg (DE)

(72) Inventors: Stefan HEINRICH, Nürnberg (DE); Dieter KRÖKEL, Nürnberg (DE); Thomas FECHNER, Nürnberg (DE); Heiko Gustav KURZ, Hannover (DE)

(21) Appl. No.: 18/553,159

(22) PCT Filed: Mar. 24, 2022
(86) PCT No.: PCT/EP2022/057733

§ 371 Date: Sep. 28, 2023

(30) Foreign Application Priority Data
Mar. 29, 2021 (DE) 10 2021 107 903.9

(51) Int. Cl. G06T 7/593; H04N 13/00; H04N 13/239; H04N 13/254

(52) U.S. Cl. CPC G06T 7/593; H04N 13/239; H04N 13/254; G06T 2207/10012; G06T 2207/10048; G06T 2207/20084; H04N 2013/0081

(57) ABSTRACT

A method for determining depth information relating to image information by an artificial neural network in a vehicle, comprising providing at least one emitter and first and second receiving sensors being spaced apart from one another; emitting electromagnetic radiation by the emitter; receiving reflected proportions of the electromagnetic radiation emitted by the emitter by the receiving sensors and generating first image information by the first receiving sensor and second image information by the second receiving sensor on the basis of the received reflected proportions; comparing the first and second image information for determining an image area unequally illuminated in the first and second image information which occurs by parallax due to the spaced-apart arrangement of the receiving sensors; evaluating geometric information of the unequally illuminated image area and estimating depth information by the artificial neural network on the basis of the evaluation of the geometric information.

### FIELD

The invention relates to a method and a system for determining depth information relating to image information provided by imaging sensors of a vehicle by means of an artificial neural network.

### BACKGROUND

It is basically known to use imaging sensors to detect the environment of the vehicle in three dimensions. For the 3D environment detection, inter alia stereo cameras are used as well. In order to calculate the distance information, the image information provided by the two cameras is correlated and triangulation is used to determine the distance of an image point from the vehicle.

The cameras for the stereo camera system are integrated, for example, in the front area of the vehicle. The installation location is usually the windshield area or the radiator grill. The front headlights of the vehicle are usually used in order to generate sufficient brightness for image evaluation at night.

A problem with current 3D environment detection is that unequally illuminated image areas in the image information obtained by the cameras of the stereo camera system make it difficult to determine depth information since no distance information can be obtained by the stereo camera system in these unequally illuminated areas. This is especially true if the different installation position between the headlights and the cameras results in a shadow cast caused by parallax.

### SUMMARY

On this basis, an object of the present disclosure is to provide a method for determining depth information relating to image information, which renders possible an improved determination of depth information.

This object is achieved by one or more embodiments disclosed herein.

According to a first aspect, the present disclosure relates to a method for determining depth information relating to image information by means of an artificial neural network in a vehicle. The neural network is preferably a convolutional neural network (CNN).

The method comprises the following steps:

First, at least one emitter and at least one first and one second receiving sensor are provided. The emitter can be designed to emit electromagnetic radiation in the spectral range visible to humans. Alternatively, the emitter can emit electromagnetic radiation in the infrared spectral range, in the frequency range of about 24 GHz or about 77 GHZ (emitter is radar emitter), or laser radiation (emitter is LIDAR emitter). The first and second receiving sensors are spaced apart from one another. The receiving sensors are adapted to the emitter type, i.e. the receiving sensors are designed to receive reflected proportions of the electromagnetic radiation emitted by the at least one emitter. In particular, the receiving sensors can be designed to receive electromagnetic radiation in the visible or infrared spectral range, in the frequency range of about 24 GHz or about 77 GHZ (radar receiver) or laser radiation (LIDAR receiver).

Subsequently, electromagnetic radiation is emitted by the emitter and reflected proportions of the electromagnetic radiation emitted by the emitter are received by the first and second receiving sensors. On the basis of the received reflected proportions, the first receiving sensor generates first image information and the second receiving sensor generates second image information.

The first and second image information are then compared to determine at least one unequally illuminated image area in the first and second image information which area occurs as a result of parallax due to the spaced-apart arrangement of the receiving sensors. If the first and second receiving sensors are not each located in the projection center of an emitter, in particular of a headlight, the unequally illuminated image area can also be produced as a result of the parallax between the respective receiving sensor and the associated emitter thereof. In other words, at least one image area is thus determined as an “unequally illuminated image area” which is, in the first image information, brighter or darker than in the second image information.

Then, geometric information of the at least one unequally illuminated image region is evaluated, and depth information is estimated by the artificial neural network based on the result of the evaluation of the geometric information of the at least one unequally illuminated image area. In other words, the size and/or the extent of the unequally illuminated image area is evaluated since this allows conclusions to be drawn by means of the neural network about the three-dimensional configuration of an object (e.g. a certain area of the object has a smaller distance from the vehicle than another area) or the distance of two objects that are located in the surrounding area of the vehicle.

The technical advantage of the proposed method is that, even from unequally illuminated areas in which depth determination is not possible by means of triangulation, the neural network can be used to draw conclusions about the distance of one or more objects represented in this unequally illuminated image area and/or around this unequally illuminated area from the geometric information of this unequally illuminated image area. Thus, a more accurate three-dimensional environment detection which is also more robust against interferences can be performed.

According to an exemplary embodiment, the unequally illuminated image area is produced in the transition area between a first object and a second object, which have a different distance from the first and second receiving sensor. Therefore, the estimated depth information is depth difference information that includes information relating to the distance difference between the first and second objects and the vehicle. This renders possible an improved separation of foreground objects and background objects. A foreground object is here an object that is provided closer to the vehicle than a background object.

Furthermore, it is possible that the unequally illuminated image area refers to a single object, the unequal illumination of the image area being produced as a result of the three-dimensional design of the single object. It is thus possible to improve the determination of three-dimensional surface forms of objects.

According to an exemplary embodiment, the emitter is at least one headlight that emits visible light in the wavelength range between 380 nm and 800 nm, and the first and second receiving sensors are each a camera. Thus, the front lighting available on the vehicle and cameras operating in the visible spectral range can be used as detection sensors.

Preferably, the first and second receiving sensors form a stereo camera system. In this case, the image information provided by the receiving sensors is correlated with one another and, on the basis of the installation positions of the receiving sensors, the distance of the respective pixels of the image information from the vehicle is determined. In this way, depth information relating to the image areas detected by the two receiving sensors can be obtained.

According to an exemplary embodiment, at least two emitters are provided in the form of the front headlights of the vehicle, and in each case one receiving sensor is assigned to a front headlight in such a way that the straight line of sight between an object to be detected and the front headlight runs substantially parallel to the straight line of sight between an object to be detected and the receiving sensor assigned to this front headlight. “Substantially parallel” means here in particular angles smaller than 10°. In particular, the receiving sensor can be very close to the projection center of the headlight assigned to it, for example have a distance smaller than 20 cm. As a result, the illumination area of the headlight is substantially equal to the detection area of the receiving sensor and a substantially parallax-free installation situation results, leading to homogeneous illumination of the detection area of the receiving sensor without illumination shadows by the headlight assigned to it.

According to an exemplary embodiment, the first and second receiving sensors are integrated into the front headlights of the vehicle. This makes it possible to achieve that the illumination area of the headlight is substantially equal to the detection area of the receiving sensor. This leads to a complete or almost complete parallax-free installation situation.

According to an exemplary embodiment, the artificial neural network performs the depth estimation on the basis of the width of the unequally illuminated image area, which is measured in the horizontal direction. Preferably, the neural network is trained to use the dependency of the width of the unequally illuminated image area on the three-dimensional form of the surrounding area that this image area represents to estimate depth information. In particular the horizontal width of the unequally illuminated image area is here suitable to determine depth differences to the unequally illuminated image area. The depth difference can here be related to a single contoured object or to multiple objects, one object (also referred to as foreground object) being located in front of another object (also referred to as background object).

It is understood that in addition to the width of the unequally illuminated image area, which is measured in the horizontal direction, further geometric information and/or dimensions of the unequally illuminated image area can also be determined in order to estimate depth information. In particular, these may be a height measured in the vertical direction or a dimension measured in the oblique direction (transverse to the horizontal line).

According to an exemplary embodiment, the artificial neural network determines depth information in image areas detected by the first and second receiving sensors on the basis of a triangulation between pixels in the first and second image information and the first and second receiving sensors. Thus, the determination of the depth information by triangulation is preferably carried out by the artificial neural network that also performs the estimation of depth information on the basis of geometric information of the unequally illuminated image area, i.e. the depth determination by triangulation and the evaluation of geometric information of an unequally illuminated image area are performed by one and the same neural network. Due to the use of a plurality of different mechanisms for determining the depth information, an improved and a more robust three-dimensional environment determination can be carried out.

According to an exemplary embodiment, the neural network compares depth information determined by triangulation and estimated depth information obtained by evaluating the geometric information of the at least one unequally illuminated image area, and generates modified depth information on the basis of the comparison. As a result, triangulation inaccuracies can be advantageously corrected so that more reliable depth information is obtained on the whole.

According to an exemplary embodiment, the artificial neural network adapts the depth information determined by triangulation on the basis of the evaluation of the geometric information of the at least one unequally illuminated image area. In other words, the depth information determined by triangulation is modified on the basis of the estimated depth information. As a result, a more robust three-dimensional environment determination is achieved.

According to an exemplary embodiment, IR radiation, radar signals, or laser radiation is emitted by the at least one emitter. Accordingly, at least part of the receiving sensors may be formed by infrared cameras, radar receivers or receivers for laser radiation. In particular, the receiving sensors are selected according to the at least one emitter with which these receiving sensors are associated. For example, the receiving sensors are provided to receive infrared (IR) radiation when they are associated with an IR emitter. In particular, emitters and receiving sensors that do not emit light in the visible wavelength range can be used to detect the surrounding area to the side of the vehicle or behind the vehicle since this would interfere with other road users. This makes it possible to provide at least partial all-round detection of the area surrounding the vehicle.

According to an exemplary embodiment, more than one emitter and more than two receiving sensors are used to determine image information for estimating depth information relating to image information representing areas to the side of the vehicle and/or behind the vehicle, a plurality of sensor groups being provided, each having at least one emitter and at least two receiving sensors, and the image information of the respective sensor groups being combined to form overall image information. In this way, an at least partial all-round detection of the surrounding area of the vehicle can be realized.

According to an exemplary embodiment, the sensor groups at least partially use electromagnetic radiation in different frequency bands. For example, in the front area of the vehicle, a stereo camera system can be employed that uses an emitter which emits light in the visible spectral range, whereas in the side areas of the vehicle e.g. emitters that use IR radiation or radar radiation are employed.

According to a further aspect, the present disclosure relates to a system for determining depth information relating to image information in a vehicle, comprising a computer unit executing arithmetic operations of an artificial neural network, at least one emitter designed to emit electromagnetic radiation, and at least one first and one second receiving sensor that are arranged in spaced-apart relation to one another. The first and second receiving sensors are configured to receive reflected proportions of electromagnetic radiation emitted by the emitter. The first receiving sensor is configured to generate first image information and the second receiving sensor is configured to generate second image information on the basis of the received reflected proportions. The artificial neural network is configured to:
compare the first and second image information to determine at least one image area unequally illuminated in the first and second image information, the unequally illuminated image area occurring as a result of the spaced-apart arrangement of the receiving sensors due to parallax;
evaluate the geometric information of the at least one unequally illuminated image area, and estimate depth information on the basis of the result of evaluating the geometric information of the at least one unequally illuminated image area.

If the first and second receiving sensors are not each located in the projection center of an emitter, in particular of a headlight, the unequally illuminated image area can also be produced by the parallax between the respective receiving sensor and the emitter associated therewith.

“Image information” in the sense of the disclosure is understood to mean any information on the basis of which a multi-dimensional representation of the vehicle environment can be made. In particular, this is information provided by imaging sensors, for example a camera, a RADAR sensor or a LIDAR sensor.

“Emitters” within the meaning of the present disclosure are understood to mean transmitting units designed to emit electromagnetic radiation. These are e.g. headlights, infrared emitters, RADAR emitting units or LIDAR emitting units.

The expressions “approximately”, “substantially” or “about” mean in the sense of the present disclosure deviations from the respective exact value by +/−10%, preferably by +/−5% and/or deviations in the form of changes that are insignificant for the function.

Further developments, advantages and possible uses of the present disclosure also result from the following description of exemplary embodiments and from the drawings. In this connection, all the features described and/or illustrated are in principle the subject matter of the present disclosure, either individually or in any combination, irrespective of their summary in the claims or their back-reference. Furthermore, the content of the claims is made a part of the description.

### BRIEF DESCRIPTION OF THE DRAWINGS

The present disclosure will be explained in more detail below with reference to the drawings by means of exemplary embodiments. In the drawings:

FIG. 1 shows, by way of example, a schematic representation of a vehicle with a stereo camera system designed to detect objects in front of the vehicle;

FIG. 2 shows, by way of example, a schematic representation of first image information detected by a first detection sensor, on which the two objects and unequally illuminated areas in the transition area between the objects are recognizable;

FIG. 3 shows, by way of example, a schematic representation of second image information which is detected by a second detection sensor and on which the two objects and unequally illuminated areas in the transition area between the objects are recognizable;

FIG. 4 shows, by way of example, a schematic representation of a vehicle having a plurality of sensor groups designed to detect objects in the surrounding area of the vehicle; and

FIG. 5 shows, by way of example, a flowchart illustrating the steps of a method for determining depth information relating to image information by means of an artificial neural network.

### DETAILED DESCRIPTION

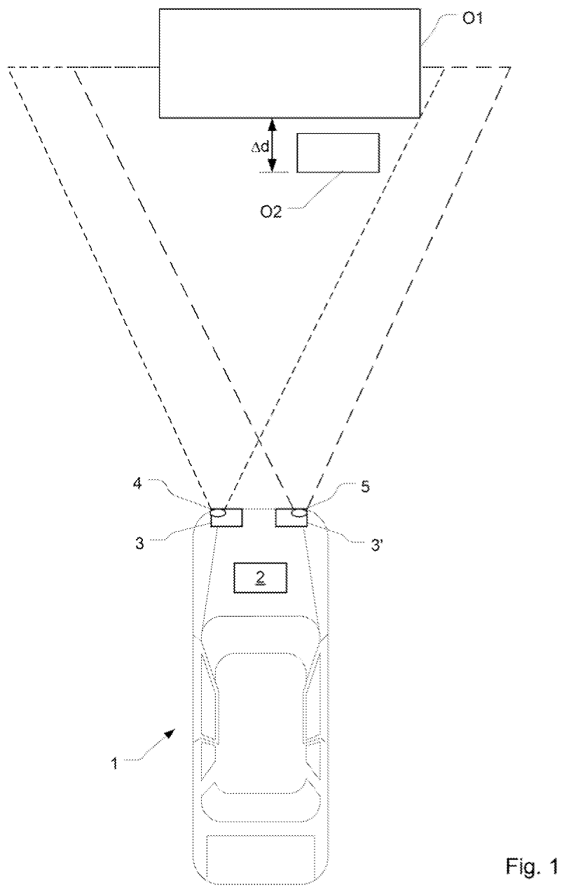

FIG. 1 shows, by way of example, a vehicle 1 equipped with a stereo camera system. The stereo camera system comprises a first receiving sensor 4 and a second receiving sensor 5, which are for example image recording devices, in particular cameras. Furthermore, the vehicle 1 comprises a first emitter 3 and a second emitter 3′, which are for example formed by the front headlights of the vehicle 1. Accordingly, the emitters 3, 3′ are designed to emit light visible to humans, in particular in the wavelength range between 380 nm and 800 nm. The receiving sensors 4, 5 are thus designed to receive light in this wavelength range and provide image information. In particular, the first receiving sensor 4 provides first image information B1 and the second receiving sensor 5 provides second image information B2.

In order to evaluate the image information B1, B2 provided by the receiving sensors, the vehicle 1 comprises a computing unit 8 which is designed to evaluate the image information B1, B2. In particular, the computing unit 8 is designed to generate depth information from image information B1, B2 of the at least two receiving sensors 4, 5 in order to render possible a three-dimensional detection of the environment around the vehicle 1.

In order to evaluate the image information B1, B2, an artificial neural network 2 is implemented in the computing unit 8. The artificial neural network 2 is designed and trained in such a way that, on the one hand, it calculates depth information relating to the image information B1, B2 by means of triangulation and then checks or modifies this calculated depth information by means of depth information estimation, which determines unequally illuminated image areas by means of a comparison of the image information B1, B2, evaluates their geometry or dimensions and, on this basis, determines estimated depth information, on the basis of which the adjustment of the depth information calculated by means of triangulation can be made.

FIG. 1 shows a first object O1 and a second object O2, which are located in front of the vehicle 1 and can be illuminated by the front headlights of the vehicle 1. The receiving sensors 4, 5 can receive those proportions of the light emitted by the front headlights that are reflected by the objects O1, O2.

The objects O1, O2 have a different distance from the vehicle 1. In addition, the second object O2 is located in front of the first object O1—from the point of view of the vehicle 1 and with reference to the straight line of sight between the objects O1, O2 and the receiving sensors 4, 5. The front side of the second object O2 facing the vehicle 1 is provided, for example, a stretch of way Δd in front of the front side of the first object O1 that also faces the vehicle 1.

Due to the spaced-apart arrangement of the emitters 3, 3′ (in this case the front headlights of the vehicle 1) and the receiving sensors 4, 5, differences in brightness are produced in the first and second image information B1, B2 as a result of the parallax, i.e. the first receiving sensor 4 provides image information B1 with brightness differences in other areas than in the second image information B2 generated by the second receiving sensor 5.

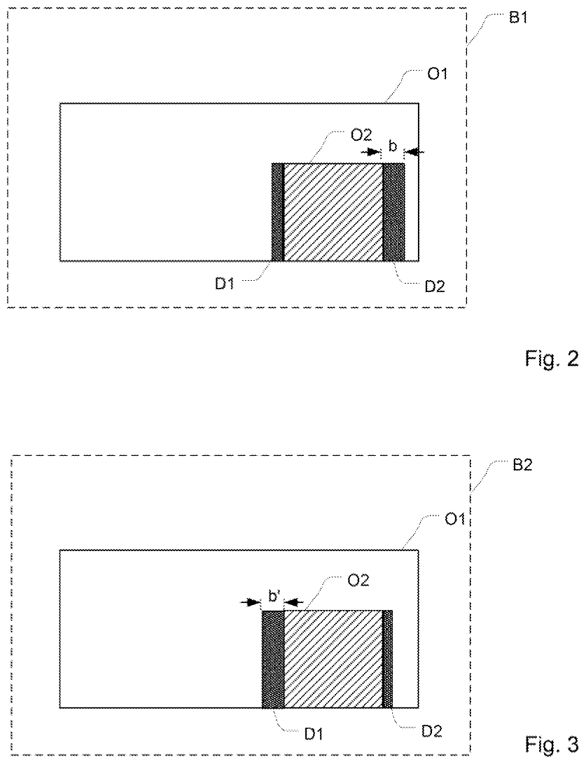

FIGS. 2 and 3 show this effect exemplarily and schematically. FIG. 2 shows by way of example first image information B1 provided by the first receiving sensor 4, which is provided on the left side of the vehicle 1 in the forward travel direction FR of the vehicle 1. Two unequally illuminated image areas D1, D2 can be seen, which are produced by the fact that the scene depicting these image areas D1, D2 is illuminated by only one emitter 3, 3′ in each case and the first receiving sensor 4 sees the objects O1, O2 from the front in a viewing direction from obliquely on the left. The unequally illuminated image area D2 thus has a greater width b (measured in the horizontal direction) than the unequally illuminated image area D1.

FIG. 3 shows, by way of example, second image information B2 provided by the second receiving sensor 5, which is provided on the right side of the vehicle 1 in the forward travel direction FR of the vehicle 1. Also in the second image information B2, two unequally illuminated image areas D1, D2 can be seen, which are in turn produced by the fact that the scene which these image areas D1, D2 depict is illuminated by only one emitter 3, 3′ in each case and the second receiving sensor 4 sees the objects O1, O2 from the front in a viewing direction from obliquely on the right. As a result, the unequally illuminated image area D1 has a greater width b′ (measured in the horizontal direction) than the unequally illuminated image area D2.

It should be noted that due to the spacing of the receiving sensors 4, 5 from one another, one emitter 3 is sufficient to generate unequally illuminated image areas D1, D2 in the first and second image information B1, B2. However, it is advantageous if one emitter 3, 3′ is assigned to each receiving sensor 4, 5 and these emitters 3, 3′ are each located in the vicinity of the receiving sensor 4, 5 assigned to them, “in the vicinity” meaning in particular distances smaller than 20 cm. Preferably, the reception sensor 4, 5 is integrated in the emitter 3, 3′, for example as a camera integrated in the headlight.

The neural network 2 is designed to compare the image information B1, B2 with one another, to determine unequally illuminated image areas D1, D2 and to estimate depth information by evaluating geometry differences existing between the unequally illuminated image areas D1, D2 in the first and second image information B1, B2.

As already stated above, the neural network 2 is configured to determine by triangulation the distance of the vehicle 1 from areas of the detected scene which are visible through the first and second receiving sensors 4, 5 and thus visible on both image information B1, B2. In this process, for example, the image information B1, B2 is combined to form an overall image and depth information is calculated for the pixels of the overall image corresponding to an area shown in the two image information B1, B2.

The disadvantage here is that no depth information can be calculated for areas of a background object, in FIGS. 2 and 3 the object O1, which are not visible in the two image information B1, B2 due to parallax (in FIGS. 2 and 3 the unequally illuminated areas D1 and D2).

However, by an estimation process of the neural network 2, it is possible to estimate depth information by comparing the geometric dimensions of the unequally illuminated areas D1, D2 in the image information B1, B2. In particular, the width of the unequally illuminated areas D1, D2, which is measured in the horizontal direction, can be used to estimate depth information. For example, the neural network 2 can infer the distance Δd of the objects O1, O2, i.e. in the illustrated exemplary embodiment, how far the object O2 is arranged in front of the object O1, by comparing the geometric dimensions of the unequally illuminated areas D1, D2. Thus, an estimated depth information is obtained, on the basis of which a correction of the depth information calculated by triangulation is possible. This leads to modified depth information that is used for the three-dimensional representation of the vehicle environment.

For example, if a distance Δd of 2 m between objects O1 and O2 is calculated by means of triangulation at a determined pixel, but the depth estimation on the basis of the unequally illuminated areas merely indicates a distance of 1.8 m between objects O1 and O2, the depth information obtained by triangulation can be modified on the basis of the estimated depth information so that the modified depth information indicates, for example, a distance Δd of 1.9 m between the objects O1, O2.

It is understood that on the basis of the comparison of the unequally illuminated areas D1, D2, it is also possible to determine to which object O1, O2 these areas can be assigned and, as a result, depth estimation is also possible in areas that cannot be detected by both receiving sensors 4, 5.

For training the neural network 2, it is possible to use training data in the form of image information pairs simulating an environment in the vehicle area. In this case, the image information of the image information pairs are representations of the same scene from different directions, namely as the detection sensors 4, 5, 6, 6′, which are spaced apart from one another, perceive the scene from their detection position. The image information of the image information pairs also have unequally illuminated image areas, which are created by at least one, preferably two emitters 3, 3′. In the training data, depth information is also available relating to the unequally illuminated image areas. This makes it possible to train the neural network 2 and adjust its weighting factors in such a way that the depth information estimated from the geometric information of the unequally illuminated image areas approximates the actual depth information.

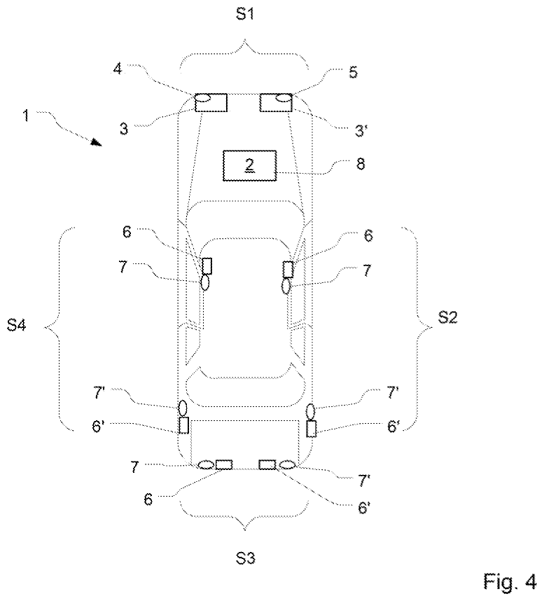

FIG. 4 shows a vehicle 1 which is provided with a plurality of sensor groups S1-S4 for detecting environment information of the vehicle. For example, sensor group S1 is provided for detecting the environment in front of vehicle 1, sensor group S2 is provided for detecting the environment to the right of vehicle 1, sensor group S3 is provided for detecting the environment behind vehicle 1, and sensor group S4 is provided for detecting the environment to the left of vehicle 1, for example.

Sensor groups S1-S4 each have at least one emitter 6, 6′, preferably at least two emitters 6, 6′, and at least two detection sensors 7, 7′ in each case.

The sensors of the respective sensor groups S1-S4 each generate three-dimensional partial environment information in their detection area, as described above. Preferably, the detection areas of the sensor groups S1-S4 overlap and thus also the partial environment information provided by them. Advantageously, this partial environment information can be linked to form an overall environment information, the overall environment information being, for example, an all-around environment representation (360°) or a partial all-around environment representation (for example, greater than 90° but less than 360°).

Since lateral or rear illumination with visible light similar to the front headlights is not possible, sensor groups S2 to S4 can emit electromagnetic radiation in the non-visible wavelength range, for example IR radiation, radar radiation or laser radiation. Thus the emitters 6, 6′ can be, for example, infrared light emitters, radar emitters or LIDAR emitters. The receiving sensors 7, 7′ are here adapted in each case to the radiation of the corresponding emitters 6, 6′, i.e. IR receiver, radar receiver or LIDAR receiver.

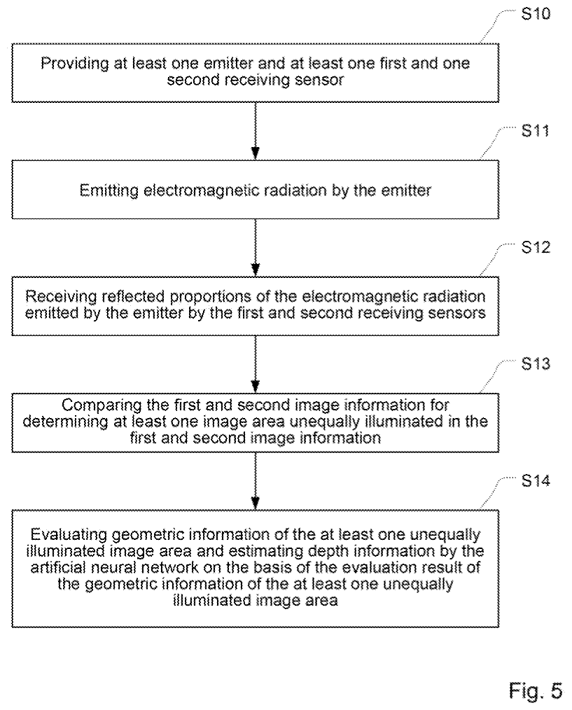

FIG. 5 shows a diagram which illustrates the steps of a method for determining depth information relating to image information by means of an artificial neural network 2 in a vehicle 1.

First, at least one emitter and at least one first and one second receiving sensor are provided (S10). The first and second receiving sensors are here spaced apart from one another.

Subsequently, electromagnetic radiation is emitted by the emitter (S11). This can be, for example, light in the visible spectral range, in the infrared spectral range, laser light or radar radiation.

Then, reflected proportions of the electromagnetic radiation emitted by the emitter are received by the first and second receiving sensors, and first image information is generated by the first receiving sensor and second image information is generated by the second receiving sensor on the basis of the received reflected proportions (S12).

Thereafter, the first and second image information is compared to determine at least one image area unequally illuminated in the first and second image information (S13). The unequally illuminated image area here results due to the spaced-apart arrangement of the receiving sensors by the parallax.

Subsequently, the geometric information of the at least one unequally illuminated image area is evaluated and depth information is estimated by the artificial neural network on the basis of the result of the evaluation of the geometric information of the at least one unequally illuminated image area (S14).

The invention has been described above with reference to exemplary embodiments. It is understood that numerous modifications as well as variations are possible without leaving the scope of protection defined by the claims.

### LIST OF REFERENCE SIGNS

1 vehicle
2 neural network
3 first emitter
3′ second emitter
4 first receiving sensor
5 second receiving sensor
6, 6′ emitter
7.7 receiving sensor
8 computing unit
b, b′ width
B1 first image information
B2 second image information
D1, D2 unequally illuminated area
Δd distance/stretch of way
O1 first object
O2 second object
S1-S4 sensor groups

1. A method for determining depth information relating to image information by an artificial neural network in a vehicle, comprising the following steps:
providing at least one emitter and at least one first and one second receiving sensor, the first and second receiving sensors being spaced apart from one another;
emitting electromagnetic radiation by the at least one emitter;
receiving reflected proportions of the electromagnetic radiation emitted by the at least one emitter by the first and second receiving sensors and generating first image information by the first receiving sensor and second image information by the second receiving sensor on the basis of the received reflected proportions;
comparing the first and second image information for determining at least one image area which is unequally illuminated in the first and second image information and which occurs by the parallax due to the spaced-apart arrangement of the receiving sensors;
evaluating geometric information of the at least one unequally illuminated image area and estimating depth information by the artificial neural network on the basis of a result of the evaluation of the geometric information of the at least one unequally illuminated image area.

2. The method according to claim 1, wherein the unequally illuminated image area occurs in the transition area between a first object and a second object which have a different distance from the first and second receiving sensors and wherein the estimated depth information is depth difference information containing information relating to a distance difference between the first and second objects and the vehicle.

3. The method according to claim 1, wherein the at least one emitter is at least one headlight emitting visible light in the wavelength range between 380 nm and 800 nm and wherein the first and second receiving sensors are each a camera.

4. The method according to claim 1, wherein the first and second receiving sensors form a stereo camera system.

5. The method according to claim 1, wherein the at least one emitter includes front headlights of the vehicle, and in each case one receiving sensor is assigned to a front headlight in such a way that the straight line of sight between an object to be detected and the front headlight runs substantially parallel to the straight line of sight between an object to be detected and the receiving sensor assigned to the front headlight.

6. The method according to claim 1, wherein the first and second receiving sensors are integrated in front headlights of the vehicle.

7. The method according to claim 1, wherein the artificial neural network estimates the depth information on the basis of the width (b), measured in the horizontal direction, of the unequally illuminated image area.

8. The method according to claim 1, wherein the artificial neural network determines depth information in image areas detected by the first and second receiving sensors on the basis of a triangulation between pixels in the first and second image information and the first and second receiving sensors.

9. The method according to claim 8, wherein the neural network compares depth information determined by triangulation and estimated depth information obtained by evaluating the geometric information of the at least one unequally illuminated image area and generates modified depth information on the basis of the comparison.

10. The method according to claim 8, wherein the artificial neural network modifies depth information obtained by triangulation on the basis of the evaluation of the geometric information of the at least one unequally illuminated image area.

11. The method according to claim 1, wherein the at least one emitter emits IR radiation, radar signals or laser radiation.

12. The method according to claim 11, wherein at least part of the receiving sensors are infrared cameras, radar receivers or receivers for laser radiation.

13. The method according to claim 1, wherein, for estimating depth information relating to image information representing areas laterally adjacent to the vehicle and/or behind the vehicle, more than one emitter and more than two receiving sensors are used to determine image information, a plurality of sensor groups being provided which each have at least one emitter and at least two receiving sensors, and the image information of the respective sensor groups being combined to form overall image information.

14. The method according to claim 13, wherein the sensor groups at least partially use electromagnetic radiation in different frequency bands.

15. A system for determining depth information relating to image information in a vehicle, comprising a computer unit which executes arithmetic operations of an artificial neural network, at least one emitter which is configured to emit electromagnetic radiation, and at least one first and one second receiving sensor which are arranged at a distance from one another, the first and second receiving sensors being configured to receive reflected proportions of the electromagnetic radiation emitted by the at least one emitter, and the first receiving sensor being configured to generate first image information and the second receiving sensor being configured to generate second image information on the basis of the received reflected proportions, the artificial neural network being configured to:
compare the first and second image information for determining at least one image area unequally illuminated in the first and second image information, the unequally illuminated image area occurring by the parallax due to the spaced-apart arrangement of the receiving sensors;
evaluating geometric information of the at least one unequally illuminated image area and estimating depth information on the basis of a result of the evaluation of the geometric information of the at least one unequally illuminated image area.
